(19) United States
(12) Patent Application Publication
(10) Pub. No.: US 2015/0323975 A1
(43) Pub. Date: Nov. 12, 2015

(54) SYNCHRONIZATION OF ACTIVITY OF MULTIPLE SUBSYSTEMS IN A SoC TO SAVE STATIC POWER

(71) Applicant: Qualcomm Innovation Center, Inc., San Diego, CA (US)

(72) Inventors: Sravan Kumar Ambapuram, Hyderabad (IN); Krishna V.S.S.S.R. Vanka, Hyderabad (IN); Shirish Kumar Agarwal, Hyderabad (IN)

(73) Assignee: Qualcomm Innovation Center, Inc., San Diego, CA (US)

(21) Appl. No.: 14/275,563

(22) Filed: May 12, 2014

(51) Int. Cl. G06F 1/32; G06F 13/42; G06F 13/28

(52) U.S. Cl. CPC G06F 1/3275; G06F 13/28; G06F 13/4234

(57) ABSTRACT

The present disclosure relates to synchronization and parallel operation of two or more cores within a multi-core computing system so as to reduce an amount of time that all cores are operating during a processing period and thereby increase an amount of idle time per processing period. In this way deeper sleep and/or idle states for the cores and the system can be entered.

### BACKGROUND

1. Field

The present disclosure relates generally to power savings in multi-core computing systems, and more specifically to synchronizing operation of multiple cores in a multi-core system.

2. Background

With the advent of multiple processors or multiple cores on a single chip (also known as SOCs), processing tasks have been distributed to various processors or cores that specialize in a given function. For instance, some smartphones now comprise a core for OS activities including audio decoding, a core for video decoding, a core for rendering and composing graphical frames, a core for composing frames, another core for handling WiFi data, and yet another core for telephony. While some cores on multi-core processors operate in parallel or at least partially in parallel, many of them operate sequentially—each only operating once data is received from a preceding core in a sequential chain of cores. When all cores in a system or a subsystem are not processing data they are able to enter one of various sleep modes where power consumption is reduced, and the longer this idle period the deeper the sleep mode that can be entered (and hence the more power that can be conserved). When cores operate sequentially, there are only short idle periods where all cores are idle and thus the device is not able to enter its deepest modes of sleep.

As an example, FIG. 1 illustrates core activity for video playback in a multi-core processor of a smartphone. The three illustrated core activity plots are charted as a function of time (x-axis). Protocol dictates that one frame can be processed in a processing period (e.g., 33 ms), so only a little more than one processing period is shown. First the applications core (or “apps core”) reads the media and writes it to memory from time t₁ to time t₂ (e.g., from an SD card to a memory of a smartphone) (102). A Digital Signal Processing core (or “DSP core”), then reads the processed data from the memory, decodes the processed data, and writes the decoded data back to the memory between times t₃ and t₄ (104). Upon completing the decoding, the DSP core informs the apps core that it has processed the data between times t₄ and t₅ (106). An MDP core then reads the decoded data from the memory and processes the decoded data and writes the processed decoded data to memory between times t₅ and t₆ (108). The MDP core then informs the apps core that it has processed the data between times t₆ and t₇ (110). As seen, the cores operate sequentially and must wait for each other—must wait until a preceding core has processed a given data block.

Once the MDP core has informed the apps core that it has processed the data (time t₆), no more core activity occurs until t₈, when the apps core begins reading the next media frame. So, between t₇ and t₈ the system can enter a sleep mode, but due to the short nature of this idle period, the system cannot select a very deep sleep mode. A duration of the idle period is determined based on an expected next activity of any one or more cores. A timer typically expires and triggers a next activity, and thus the difference between an expiry timer and the current time gives an idle period. The cores themselves can also enter various sleep modes when they are not in operation. For instance, the apps core can enter a deeper sleep state between t₂ and t₄, then between t₅ and t₆. There is therefore a need in the art for systems and methods to enable multi-core systems, where two or more cores operate sequentially, to see longer system and core idle times and thus deeper modes of sleep.

### SUMMARY

Embodiments disclosed herein address the above stated needs by providing a multi-core system that triggers each of the multiple cores to begin processing at the same time and once per processing period. Cores that have to operate sequentially can be instructed to process different data blocks each processing period, such that they operate sequentially relative to a given data block, but in parallel for a given processing period.

One aspect of the disclosure can be described as a multi-core system comprising a peripheral memory device, a controller, a memory, a first core, and a second core. The peripheral memory device can comprise data to be read and processed. The controller can send a control signal once per processing period. The first core can be coupled to the memory and coupled to the controller so as to receive the control signal and to read a first portion of the data from the peripheral memory device upon receipt of a first instance of the control signal. The first core can further process the first portion of the data and convert it to a processed first portion of the data. The first core can then write the processed first portion of the data to the memory and the first core can further be configured to read a second portion of the data from the peripheral memory device upon receipt of a second instance of the control signal.

Another aspect of the disclosure can be described as a method of operating a multi-core system. The method can include sending a first instance of a control signal to two or more cores of a computing device. The method can further include, upon receiving a first instance of the control signal, reading, via a first of the two or more cores, a first portion of data from a peripheral memory device, processing the first portion of data from a peripheral memory device, processing the first portion of data, and writing the first portion of data to a memory. The method can further include sending a second instance of the control signal to the two or more cores of the computing device. The method can yet further include, upon receiving the second instance of the control signal, reading, via the first of the two or more cores, a second portion of data from the peripheral memory device. The method can also include, upon receiving the second instance of the control signal, reading, via the second of the two or more cores, the first portion of data from the memory.

Yet another aspect of the disclosure can be described as a non-transitory, tangible computer readable storage medium, encoded with processor readable instructions to perform a method for operating a multi-core system. The method can include sending a first instance of a control signal to two or more cores of a computing device. The method can further include, upon receiving a first instance of the control signal, reading, via a first of the two or more cores, a first portion of data from a peripheral memory device, processing the first portion of data from a peripheral memory device, processing the first portion of data, and writing the first portion of data to a memory. The method can further include sending a second instance of the control signal to the two or more cores of the computing device. The method can yet further include, upon receiving the second instance of the control signal, reading, via the first of the two or more cores, a second portion of data from the peripheral memory device. The method can also include, upon receiving the second instance of the control signal, reading, via the second of the two or more cores, the first portion of data from the memory.

### BRIEF DESCRIPTION OF THE DRAWINGS

FIG. 1 is a timing chart for an apps core, DSP core, and an MDP core operating over a least one processing period according to a method known in the art;

FIG. 2 is a timing chart for an apps core, DSP core, and an MDP core operating over at least one processing period according to a novel method disclosed herein;

FIG. 3 is a timing chart for multiple cores of a computing device operating over multiple processing periods according to a novel method as disclosed herein;

FIG. 4 is a system diagram of an exemplary system for carrying out the methods herein disclosed;

FIG. 5 is another system diagram of an exemplary system for carrying out the methods herein disclosed;

FIG. 6 illustrates an embodiment of a method of operating a multi-core system;

FIG. 7 illustrates an embodiment of a method of operating a multi-core system; and

FIG. 8 is a diagrammatic representation of one embodiment of a computer system within which a set of instructions can execute for causing a device to perform or execute any one or more of the aspects and/or methodologies of the present disclosure.

### DETAILED DESCRIPTION

The term “processing period” is used herein to mean a fixed period of time during which a single block of data can be sequentially processed, although multiple blocks of data can be processed if multiple cores are operating in parallel.

The term “control signal” is used herein to mean any signal (e.g., an instruction or interrupt, to name two) that triggers two or more cores (or processors) to begin operating at the same time.

The term “peripheral memory device” is used herein to mean any memory component that is read via a peripheral bus of a computing system.

The word “exemplary” is used herein to mean “serving as an example, instance, or illustration.” Any embodiment described herein as “exemplary” is not necessarily to be construed as preferred or advantageous over other embodiments.

The term “system idle time” is used herein to mean a period during which no processors are active and hence the system can enter various system level modes of sleep.

The term “core idle time” is used herein to mean a period during which a given core is inactive and hence the core can enter various core level modes of sleep.

The term “data blocks” is used herein to mean any chunk or group of individual pieces of information, such as a frame in video playback. Other examples of data blocks include registers, bit streams, interrupts, and file systems.

By offsetting the operations of sequentially-related cores by one or more processing periods, and triggering processing of multiple cores at the same moment in a given processing period, sequentially-related cores can be operated in parallel thereby creating longer idle periods between an end of activity in a given processing period and the start of activity in a next processing period.

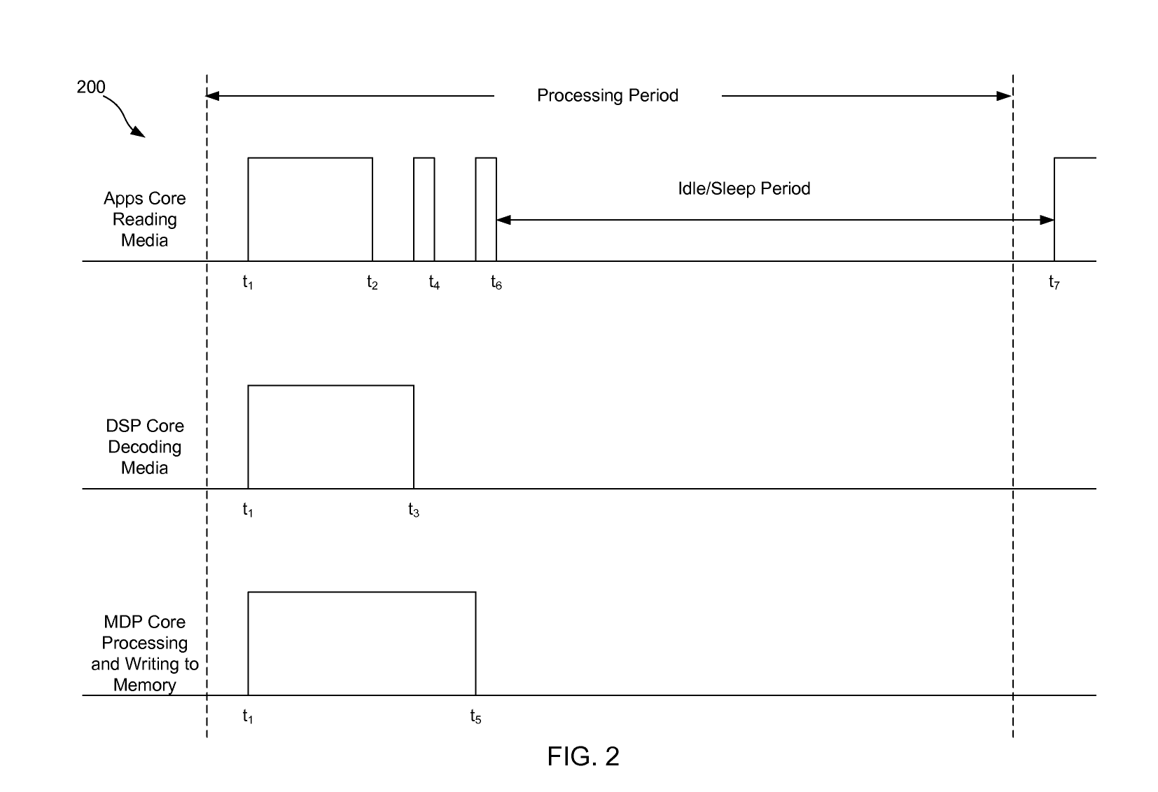

FIG. 2 illustrates timing chart for cores in a multi-core processor configured for video playback and embodying a new method of parallel core operation. In particular, all three cores are triggered so as to begin activity at the same time each processing period. Since one core cannot begin processing data from a preceding core until after the preceding core finishes processing the data, each core operates on a different data block in a given processing period. In other words, the cores are offset from each other relative to the data being processed in a given processing period. Said a different way, the cores operate on data in an offset manner where the offset between the apps core and the DSP core is one processing period and the offset between the apps core and the MDP core is two processing periods. In other words, the MDP core can be processing a data block that the DSP core processed one processing period before and that the apps core processed two processing periods before. By offsetting the data blocks that each core handles in a given processing period, the cores are able to operate in parallel (e.g., start at substantially the same time, t₁).

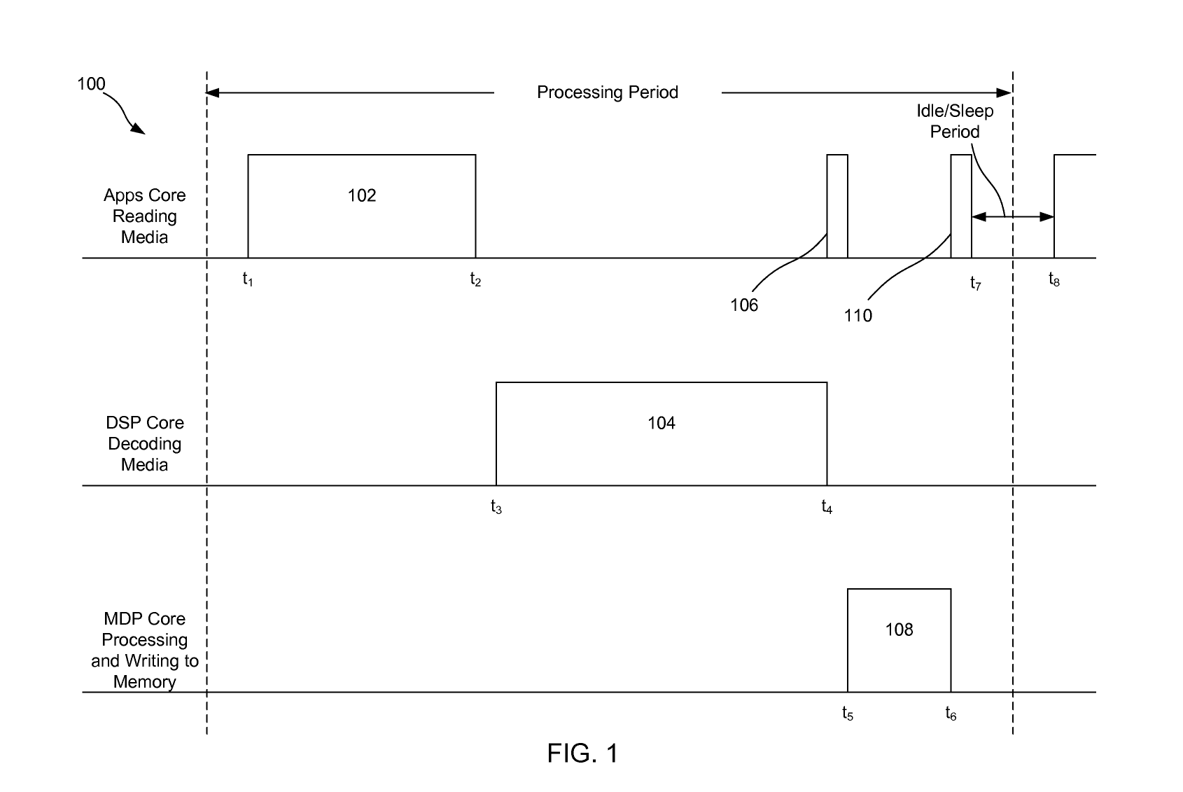

All three cores initiate processing at t₁ (e.g., as initiated via a common triggering signal or command), with core activity ending at t₆. Because the cores are able to operate in parallel, the idle or sleep period has been extended as compared to the idle or sleep period illustrated in FIG. 1. Since sleep states depend on a length of idle time, the parallel operation of FIG. 2 can achieve deeper sleep states and greater power conservation than is achieved in the prior art.

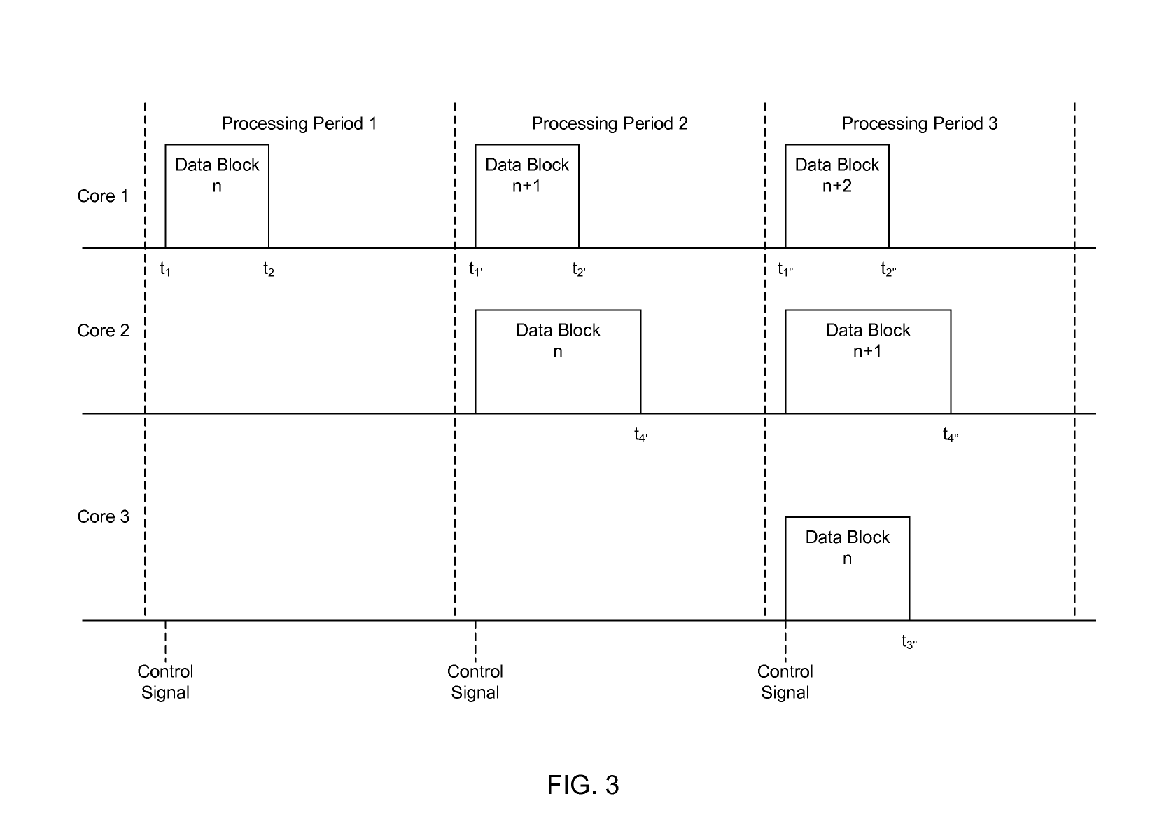

Achieving the core activity seen in FIG. 2 involves two modifications to prior art methods for operating multi-core processing and to prior art multi-core systems: (1) sequentially-related cores are offset from each other by one processing period or more; and (2) core activity is triggered at the same time (e.g., upon receipt of a control signal) during a processing period rather than triggering when data is ready to be processed. These two concepts are described below and illustrated more generally in FIG. 3.

FIG. 3 illustrates three consecutive processing periods showing activity of three cores. It should be understood that a single core can only process a single data block in a given processing period and that the illustrated cores can only process a data block that has already been processed by a preceding data block. In order to maximize the idle time of the system between the last activity in a given processing period and the start of core activity in a subsequent processing period, the data blocks that each core handles are offset from a preceding and a following core by one processing period, and all cores that have data to process are triggered to begin activity at the same time during each processing period.

More specifically, core 1 processes a first data block in processing period 1. Then, core 2 processes this first data block in a next processing period (processing period 2), while core 1 processing a second data block. In processing period 3, core 1 processes a third data block, core 2 processes the second data block, and core 3 processes the first data block.

While core 2 is offset from core 1 and core 3 by one processing period each, and core 1 is offset from core 3 by two processing periods, these offsets are not limiting, but rather can be tailored to a given system. For instance, in an embodiment, two cores can handle a given data block in the same processing period where the cores are not sequentially related to each other. For instance, a second and third core may handle audio and video decoding, respectively, for frame n during a given processing period, while another core handles data reading of frame n+1 and a fourth core handles writing of decoded data to memory for a frame n−1, all during the same processing period. In other words, there are scenarios where two different cores can process the same data block in the same processing period and thus do not have to be offset from each other. Other arrangements of offsets are also envisioned and can be implemented without departing from the scope of this disclosure.

One result of the above-noted offsets is that as processing of data blocks begins, there may be processing periods where a core remains inactive for the entirety of one or more processing periods. In FIG. 3, for instance, core 1 is the only active core during processing period 1. Additionally, it can be seen that core 3 remains inactive or idle for processing periods 1 and 2. Again, such inactivity at the start of processing of a series of data blocks is not limiting and other arrangements are also encompassed within the scope of this disclosure.

The second aspect of achieving the illustrated parallel processing and hence longer idle times is that when cores are active during a given processing period, they begin processing at or substantially at the same time. Traditionally, cores begin processing as soon as data is ready for processing. So, for sequentially-related cores, such as those illustrated in FIG. 1, cores begin processing as soon as a preceding core has completed its task on a given data block. Contrast this with FIG. 3, where traditional methods would call for core 2 to begin processing frame n at or substantially at time t₂. The result would be that cores would not operate in parallel and the idle time between t₂ and t_{1′} would be drastically reduced and a much less desirable sleep mode entered.

Instead, this disclosure suggests modifying a core activation trigger so as to trigger on a control signal rather than on indication that data from a preceding core is ready to be processed. So, a control signal is sent to the cores at some point during a given processing period. In FIG. 3 the control signal is sent toward a beginning of each processing period. This can be referred to as a system level control signal since it is sent to all cores in a given system. In some embodiments, there may be multiple systems, and hence different control signals for each system (e.g., video processing and telephony can be different systems each having their own set of multiple synchronized cores). When a core receives this control signal (e.g., an interrupt) and there is data to be processed, the core becomes active. If data is not ready to be processed or a control signal is not received, then a core remains inactive (e.g., cores 2 and 3 in processing period 1 and core 3 in processing period 2).

In the case of core 2, the first of these two requirements is met at time t₂, however no control signal has been received. However, at t_{1′}, core 2 receives a control signal and now has data to process, so it begins processing data block n. Similarly, core 3 does not have data to process until t_{4″}, does not thereafter receive a control signal until t_{1″}, and thus remains inactive until t_{1″}.

As seen, the cores still operate on a given data block in a sequential manner, but are able to operate in parallel in a given processing period. Hence, for the purposes of this disclosure, operation of the cores will be referred to as parallel while the operation of FIG. 1 will be referred to as sequential.

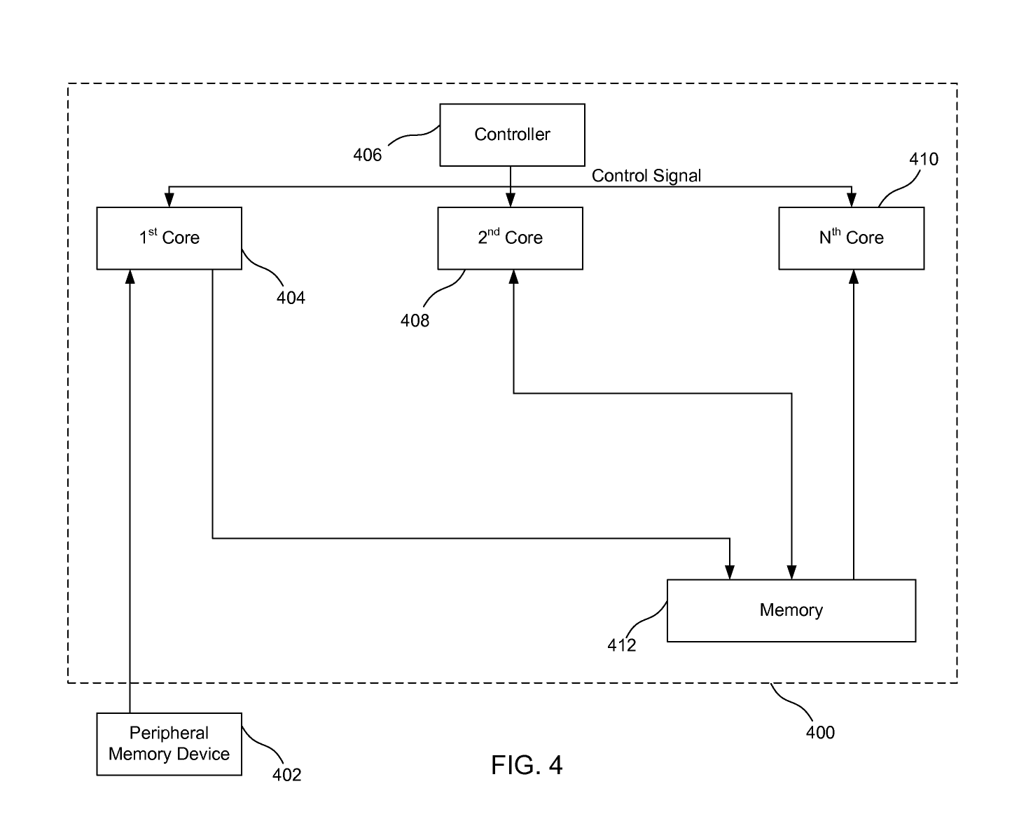

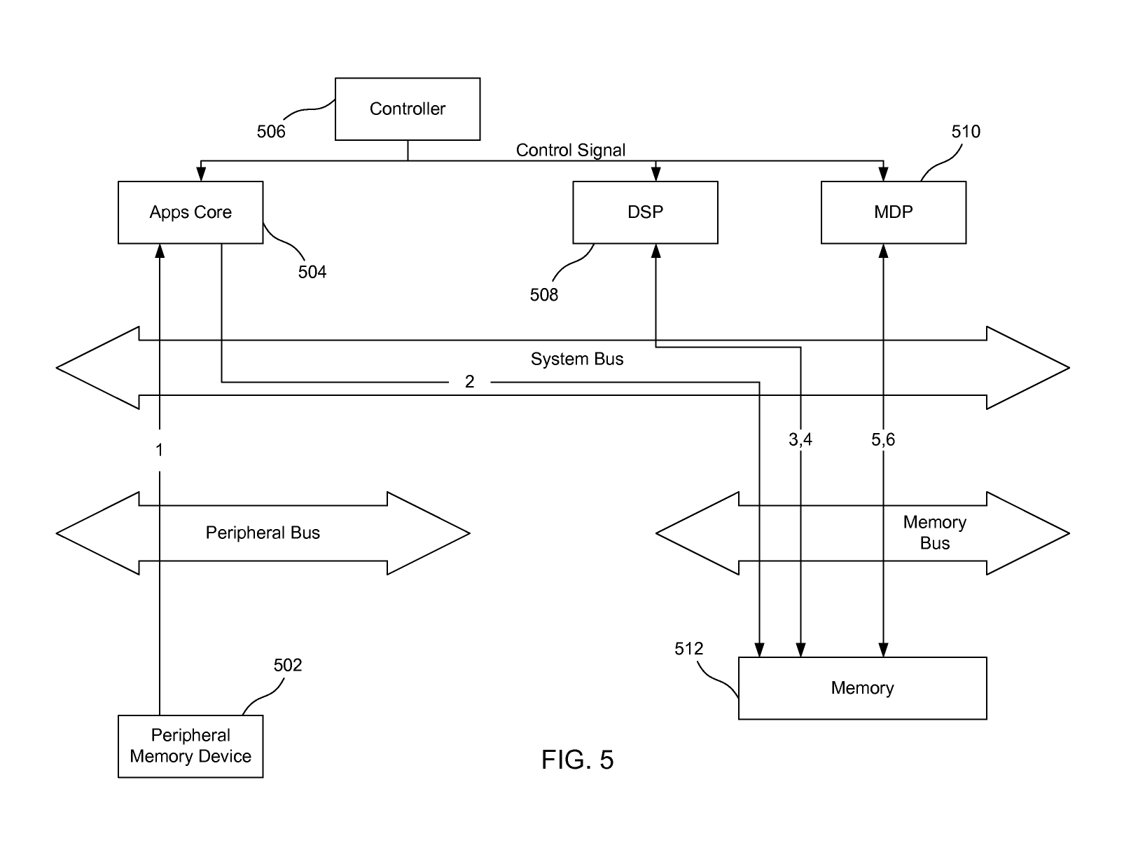

The control signal can take a variety of forms. For instance, the control signal can be an interrupt (analog or digital), timer, register read/write, shared memory communication, inter processor communication methods, file system read/write, input/output signals, function calls, and an analog wave. The control signal can be generated in hardware or software controlling hardware. In the embodiments illustrated in FIGS. 4 and 5, the control signal is generated from a controller 406, 506.

The processing periods and the duration of core activity for each of the cores in FIG. 3 are not drawn to scale nor should they be taken to imply anything about the duration of a processing period or activity of a core. Further, while the control signal is shown as occurring shortly after the start of each processing period, the control signal may be sent at any point within a processing period, even including at the moment that a processing period begins.

Additionally, this disclosure describes all cores beginning processing for a processing period at the moment that they receive the control signal. However, some variation between cores is possible without straying from the disclosure. For instance, and comparing FIGS. 1 and 2, even where the Apps core, DSP core, and the MDP core in FIG. 2 started processing substantially at t₁, but not necessarily at exactly t₁ or exactly at the same time, the idle/sleep period would still be substantially greater than that seen in the traditional sequential operation of FIG. 1.

Similarly, FIG. 3 should not be taken to limit the disclosure to systems or methods employing three cores. Rather, any number of two or more cores can be used with this method. Further, the two or more cores need not all be offset from each other. In some cases, two or more cores can operate on the same data block during a given processing period, but be offset from other cores (e.g., where one core decodes video and another decodes audio, these two cores can operate on the same data block in a given processing period while both being offset from other cores in the same processing period).

Furthermore, it should be understood that this disclosure has so far only discussed systems where each separate core has different functionality and is thus tailored for different tasks. However, in some known instances, the task of processing a given data block has been distributed between multiple cores operating at the same time (see, e.g., Kuroda et al., Multimedia Processors, Proceedings of the IEEE, Vol. 86, No. 6, June 1998). Yet, one will also note that this distribution of processing of a single data block between similar or identical cores does not overlap with the newly disclosed form of parallel processing where different cores perform different types of processing on a given data block and thus must sequentially operate on a given data block.

FIG. 4 illustrates a system for operating a multi-core computing device 400 so that otherwise sequentially-operating cores operate in parallel and thereby increase an idle and/or sleep period per processing period. This system 400 comprises two or more cores that traditionally would operate sequentially, but in order to conserve power are here described as operating in parallel in order to maximize an idle and/or sleep period during each processing period and thereby allow the system and the cores to enter deeper states of sleep. FIG. 4 will be described in combination with the timing chart for core activity illustrated in FIG. 2.

In a first processing period (e.g., processing period 1 in FIG. 3) a controller 406 sends a control signal to the two or more illustrated cores (e.g., at t₁ in FIG. 3). The two or more cores can include 1^{st} and 2^{nd} cores 404, 408, and optionally additional cores represented by the “N^{th} core” 410 in FIG. 4. Those cores with data to process proceed, which in the first processing period, is the 1^{st} core 404, so, the first core reads a first portion of data from the peripheral memory device 402, processes the first portion of data, and writes the first portion of data to the memory 412. Upon completion, all cores are able to enter a sleep mode, and optionally the system 400 can enter a sleep mode, until a next processing period (e.g., processing period 2 in FIG. 3).

In a second processing period (e.g., processing period 2 in FIG. 3) the controller 406 again sends a control signal the two or more illustrated cores (e.g., at t_{1′} in FIG. 3). Those cores with data to process now include the 1^{st} core 404 and the 2^{nd} core 408, so those cores begin operation. The first core 404 reads a second portion of the data from the peripheral memory device 402, processes the second portion of data, and writes the second portion of data to the memory 412. Starting at the same time, the 2^{nd} core 408 reads the first portion of data from the memory 412, processes it, and then writes the first portion of data back to the memory 412. When operation of both cores is complete, the cores, and optionally the system 400, are able to enter a sleep mode until the next processing period (e.g., processing period 3 in FIG. 3).

In the third processing period (e.g., processing period 3 in FIG. 3) the controller 406 again sends a control signal to the two or more illustrated cores (e.g., at t_{1′} in FIG. 3). Those cores with data to process now include the 1^{st} core 404, the 2^{nd} core 408, and the N^{th} core 410, so those cores begin operation. The first core 404 reads a third portion of the data from the peripheral memory device 402, processes the third portion of data, and writes the third portion of data to the memory 412. Starting at the same time, the 2^{nd} core 408 reads the second portion of data from the memory 412, processes it, and then writes the second portion of data back to the memory 412. Starting at the same time, the 3^{rd} core 410 reads the first portion of data from the memory 412 and process it. In some cases, the 3^{rd} core 410 may also write the first portion of data back to the memory 412 after processing it. When operation of all cores is complete, the cores, and optionally the system 400, are able to enter a sleep mode until the next processing period.

The peripheral memory device 402 can include any device or component comprising a memory and being accessed by the apps core 404 via a peripheral bus (Universal Serial Bus, Tunderbolt, PCI, PCI Express, Videoport, Fire Wire). A USB drive, DVD, BluRay, iPhone, iPod, iPad, smartphone, and BluRay player are just a few non-limiting examples of a peripheral memory device 402 or devices that include a peripheral memory device 402.

The controller 406 can be a hardware component, software module embodied in a non-transitory tangible computer readable medium, firmware, or some combination of the above. The controller 406 can include any component, device, or module configured to send a simultaneous control signal to the two or more cores that initiates parallel processing of one or more of the cores. In particular, each instance of the control signal causes one or more of the two or more cores to begin processing data if a given core has data available to process.

The two or more cores can communicate with each other and with the peripheral memory device and the memory via one or more system busses, peripheral busses, and/or memory buses, to name a few non-limiting examples.

When it is said that the system 400 enters a sleep mode it is meant that any one or more components or subsystems within the system 400 can enter a sleep mode. These include, but are not limited to, the two or more cores 404, 408, 410, buses that connect cores, memory devices (e.g., 412) and memory controllers, buses that connect cores to memory controllers, or buses that connect multiple memory devices (e.g., SD card, DDR, EMMC, etc.), to name a few examples. This can also include lowering a voltage and/or frequency of a bus when cores that use the bus are in a sleep state or lowering the voltage and/or frequency of a memory controller when all cores are in a sleep state.

FIG. 5 illustrates a system for operating a multi-core computing device 500 configured to decode media from a peripheral memory device 502 and store the same to memory 512. This system 500 comprises three cores 504, 508, 510 that traditionally would operate sequentially, but in order to conserve power are here described as operating in parallel in order to maximize an idle and/or sleep period during each processing period and thereby allow the system and the cores to enter deeper states of sleep. FIG. 5 will be described in combination with the timing chart for core activity illustrated in FIG. 2. While specific cores are described in FIG. 5, one of skill in the art will recognize that operation of this multi-core system will be similarly carried out for other systems having other combinations and numbers of cores (recall FIG. 4).

In a first processing period (e.g., processing period 1 in FIG. 3) a controller 506 sends a control signal to all cores in the illustrated system 500 (e.g., at t₁ in FIG. 3), including an apps core 504, a DSP 508, and an MDP 510. Those cores with data to process proceed, which in the first period, is the apps core 504, in the form of a first media frame on a peripheral memory device 502 (e.g., an SD card or Blu Ray disc). The apps core 504 reads the first media frame from the peripheral memory device 502, processes the first media frame, and writes the first media frame to the memory 512. The media frame passes through the peripheral bus and the system bus (path 1) to the apps core 504 where it is read, processed, and stored in memory 512 via a system bus and a memory bus (path 2). All three cores 504, 508, 510 are then able to enter a sleep mode, and optionally the system 500 can enter a sleep mode, until a next processing period (e.g., processing period 2 in FIG. 3).

In a second processing period (e.g., processing period 2 in FIG. 3) the controller 506 again sends a control signal (e.g., at t_{1′} in FIG. 3) to all cores in the illustrated system. Now the apps core 504 and the DSP 508 both have data to process, and so they both begin to operate. The apps core 504 reads a second media frame from the peripheral memory device 502, processes it, and writes it to the memory 512. Starting at the same time, the DSP 508 reads the first media frame from the memory 512 (path 3), decodes it, and then writes the decoded first media frame back to the memory 512 (path 4). The DSP 508 then informs the apps core 504 that it has completed this task, the apps core 504 informs the MDP 510 of the same, and the cores 504, 508, 510, and optionally the system, are able to enter a sleep mode until the next processing period (e.g., processing period 3 in FIG. 3).

In the third processing period (e.g., processing period 3 in FIG. 3), the controller 506 again sends a control signal (e.g., at t_{1″} in FIG. 3) to all cores in the illustrated system. Since the apps core 504, the DSP 508, and the MDP 510 all have data to process, they all begin processing at the same time—upon receipt of the control signal. The apps core 504 reads a third media frame from the peripheral memory device 502, processes it, and writes it to the memory 512. At the same time, the DSP 508 reads the second media frame from the memory 512, decodes it, and then writes the decoded second media frame back to the memory 512. The DSP 508 then informs the apps core 504 that it has competed its processing and the apps core 504 informs the MDP 510 of the same. At the same time, the MDP 510 reads the decoded first media frame from the memory 512 (path 5), processes the same, and writes it back to the memory 512 (path 6). The MDP 510 then informs the apps core 504 that it has completed this task. The system and cores are then able to enter a sleep state until the next processing period (e.g., until the next control signal is received).

The peripheral memory device 502 can include any device or component comprising a memory and being accessed by the apps core 504 via a peripheral bus (Universal Serial Bus, Tunderbolt, PCI, PCI Express, Videoport, Fire Wire). A USB drive, DVD, BluRay, iPhone, iPod, iPad, smartphone, and BluRay player are just a few non-limiting examples of a peripheral memory device 502 or devices that include a peripheral memory device 502.

The controller 506 can be a hardware component, software module embodied in a non-transitory tangible computer readable medium, firmware, or some combination of the above. The controller 506 can include any component, device, or module configured to send a simultaneous control signal to the apps core 504, the DSP 508, and the MDP 510 that initiates parallel processing of one or more of these three components. In particular, the control signal causes one or more of the apps core 504, DSP 508, or MDP 510 to begin processing data if a given core has data available to process.

The apps core 504 can read data from the peripheral memory device 502 via the system bus. The apps core 504 can write processed data to the memory 512 via the system bus and the memory bus. The DSP 508 can read and write data to the memory 512 via the system bus and the memory bus. The MDP 510 can read and write data to the memory 512 via the system bus and the memory bus.

While FIG. 5 illustrates a system comprising an apps core 504, a DSP 508, and an MDP 510, any system comprising 2 or more cores can carry out the functions described relative to FIG. 5 without departing from the scope of this invention. What is important is not the type of cores or the processing that each core performs, but that the cores process data in an offset manner at the behest of a synchronizing control signal, and thereby are able to process in parallel in a given processing cycle and thereby enable a sleep mode to begin sooner in a processing cycle than is possible via sequential operation of the two or more cores during a single processing cycle.

This disclosure uses the terms sleep and/or idle modes without specifying a type of sleep or idle mode. However, one of skill in the art is well aware that such sleep or idle modes can comprise different modes or levels depending on an amount of idle time available. For instance, there can be five levels of system level sleep, sometimes referred to as Levels 1-5. Level 1 enables the system level bus connecting multiple cores (e.g., system bus in FIG. 5) to run at lower frequencies and lower voltages. Level 2 enables the system level bus to be clock gated and powered off. Level 3 enables the system level bus connecting cores to memory (e.g., memory 412 and memory 512) to be powered off. Level 4 enables a crystal oscillator that feeds clock signals to the various cores to be turned off as well as other buses and memory. Level 5, the deepest system level sleep mode, enables system voltage to be reduced (the minimum voltage is that where the system can retain a minimum amount of data to enable restoration of the previous state when required). In some embodiments, the controller 406, 506 can determine what sleep mode to place the system in.

As another example of different modes of sleep, there can be four core level modes of sleep, sometimes referred to as Levels 1-4. In Level 1, a core idles until an interrupt is received. In Level 2, a core frequency is reduced. In Level 3, a core is powered off, but the cache remains on. In Level 4, the deepest sleep mode that a processor can enter, a core and its cache are powered off. In some embodiments, the controller 406, 506 can determine what sleep mode to place one or more cores into.

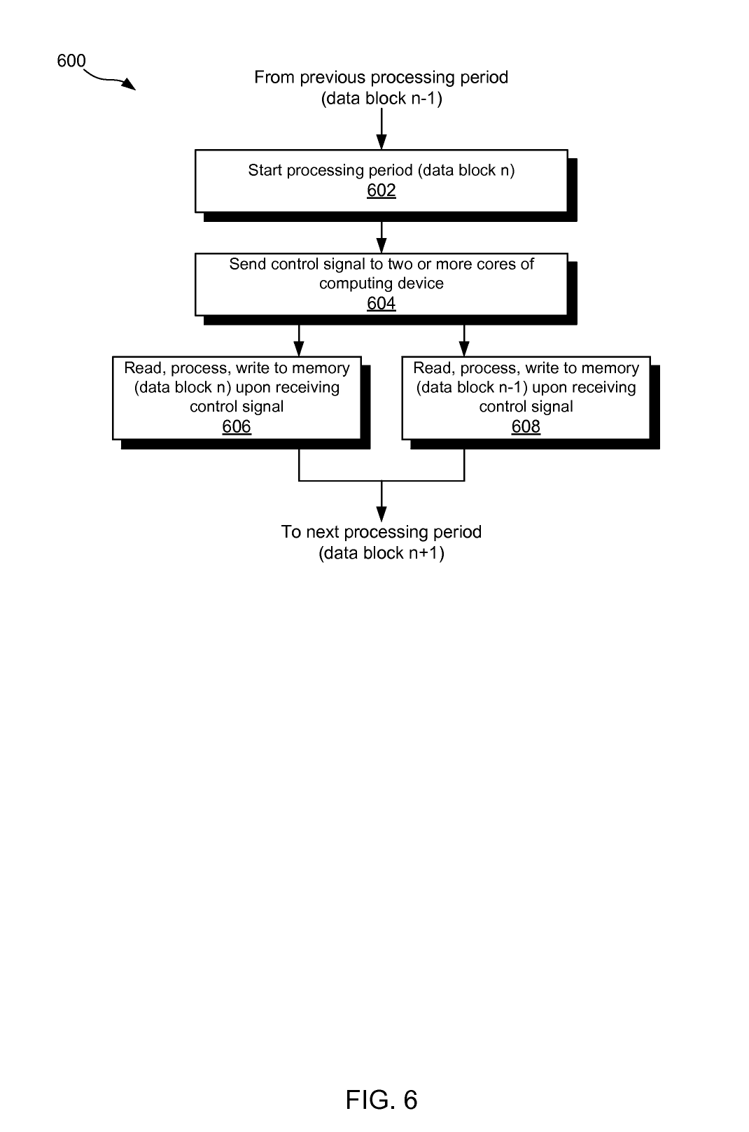

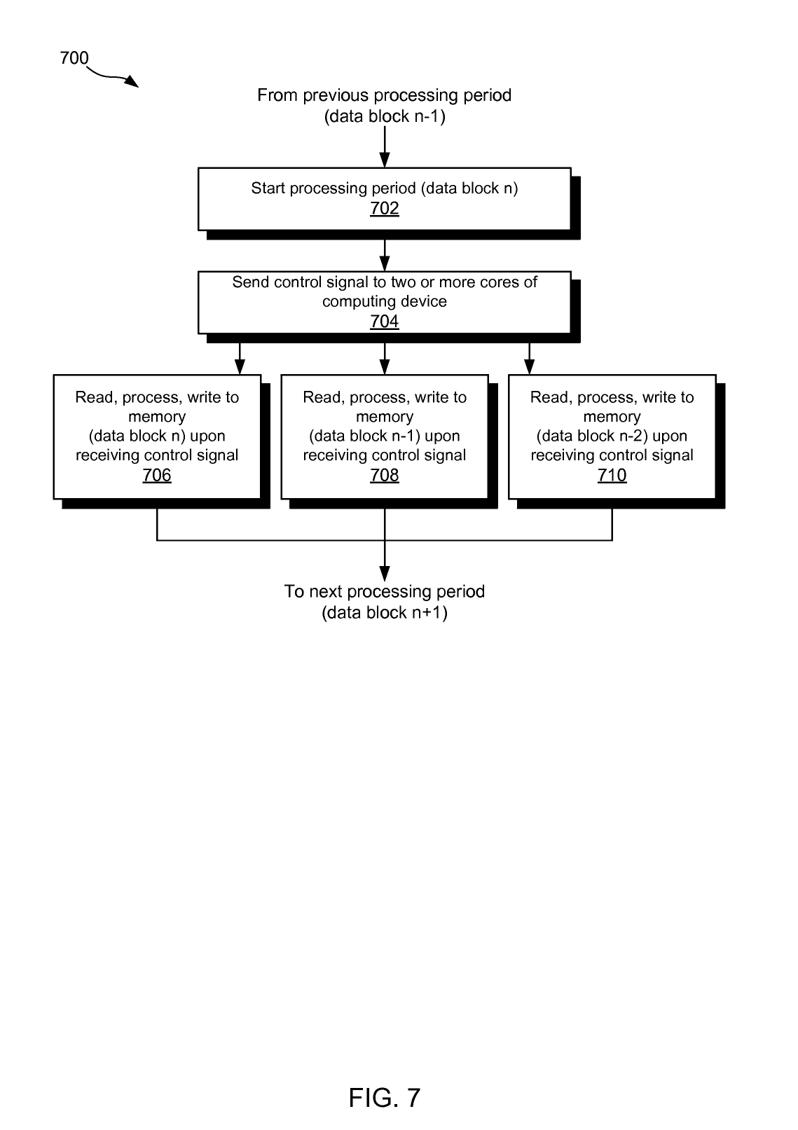

FIG. 6 illustrates an embodiment of a method of operating a multi-core system. The method 600 begins with a start of a processing period (Block 602) where a first of two or more cores of a computing device will be processing a data block n, where n is an integer value great than 0. There may have been previous processing periods, and hence prior data blocks may have already been processed, or the processing period may be the first processing period. Either way, given the start of the processing period the method 600 sends a control signal to the two or more cores (Block 604). This control signal can be referred to as a first instance of the control signal, and further instances of the control signal can be sent in each subsequent processing period. This control signal triggers processing of the two or more cores on data blocks available to each of the two or more cores and enables the cores to process in parallel, whereas traditional triggering means typically cause cores to process sequentially or in series (given cores that only process a data block once processed by a preceding data block). Upon receiving the control signal, a first core can read, process, and write to memory data block n (Block 606) while a second core reads, processes, and writes to memory a data block n−1 (or the data block that the first core processed in the previous processing period) (Block 608). If there was not a previous processing period and hence there is not a data block n−1, then the second core does not process this processing period, but will process data block n in a next processing period. If there were a third core, then the third core would read, process, and write to memory a data block n−2 upon receiving the control signal (see, e.g., FIG. 7). This pattern can be extended for any number of cores. Once all cores have completed their reading, processing, and writing, core and system idle states can be entered and at some point the next processing period will begin (e.g., where the first core handles data block n+1).

Upon receipt of the control signal, the first core can read a first portion of data from a storage device, for instance, a peripheral memory device. Processing the data involves whatever functionality the first core is responsible for (e.g., the apps core 504 in FIG. 5 processes data by retrieving it from the peripheral memory device 502 and writing it to the memory 512). The first core then writes the processed data to a memory of the computing device, such as the memory 412 or 512 in FIGS. 4 and 5.

Where the first core has previously processed data (e.g., data block n−1), receipt of the control signal can trigger the second core to read, process, and write data previously processed by the first core (e.g., data block n−1), in parallel with the first core's processing of a different block of data (e.g., data block n). The reading by the second core can involve reading the first portion of data from the memory. Processing by the second core can involve processing the first portion of data and this processing depends on the functionality of the second core. For instance, the DSP 508 in FIG. 5 decodes data in the memory 512 that the Apps core 504 read from the peripheral memory device 502. The writing by the second core can involve writing the first portion of data back to the memory (or another memory) once the second core has processed the first portion of data.

The control signal can be sent by a controller such as controller 406 in FIG. 4 or controller 506 in FIG. 5. The two or more cores can be embodied by the 1^{st} through n^{th} cores 404, 408, 410 of FIG. 4, or the apps core 504, DSP 508, and MDP 510 of FIG. 5.

FIG. 7 illustrates an embodiment of a method of operating a multi-core system. The method 700 begins with a start of a processing period (Block 702) where a first of two or more cores of a computing device will be processing a data block n, where n is an integer value great than 0. There may have been previous processing periods, and hence prior data blocks may have already been processed, or the processing period may be the first processing period. Either way, given the start of the processing period the method 700 sends a control signal to the two or more cores (Block 704). This control signal can be referred to as a first instance of the control signal, and further instances of the control signal can be sent in each subsequent processing period. This control signal triggers processing of the two or more cores on data blocks available to each of the two or more cores and enables the cores to process in parallel, whereas traditional triggering means typically cause cores to process sequentially or in series (given cores that only process a data block once processed by a preceding data block). Upon receiving the control signal, a first core can read, process, and write to memory data block n (Block 706) while a second core reads, processes, and writes to memory a data block n−1 (or the data block that the first core processed in the previous processing period) (Block 708) while a third core reads, processes, and writes to memory a data block n−2 (or the data block that the first core processed two processing periods previously and that the second core processed in the previous processing period) (Block 710). If there was not a previous processing period and hence there is not a data block n−1 or n−2, then the second and third cores do not process this processing period, but the second core will at least process data block n in the next processing period and in a processing period after that, the third core will process data block n. This pattern can be extended for any number of cores. Once all cores have completed their reading, processing, and writing, core and system idle states can be entered and at some point the next processing period will begin (e.g., where the first core handles data block n+1).

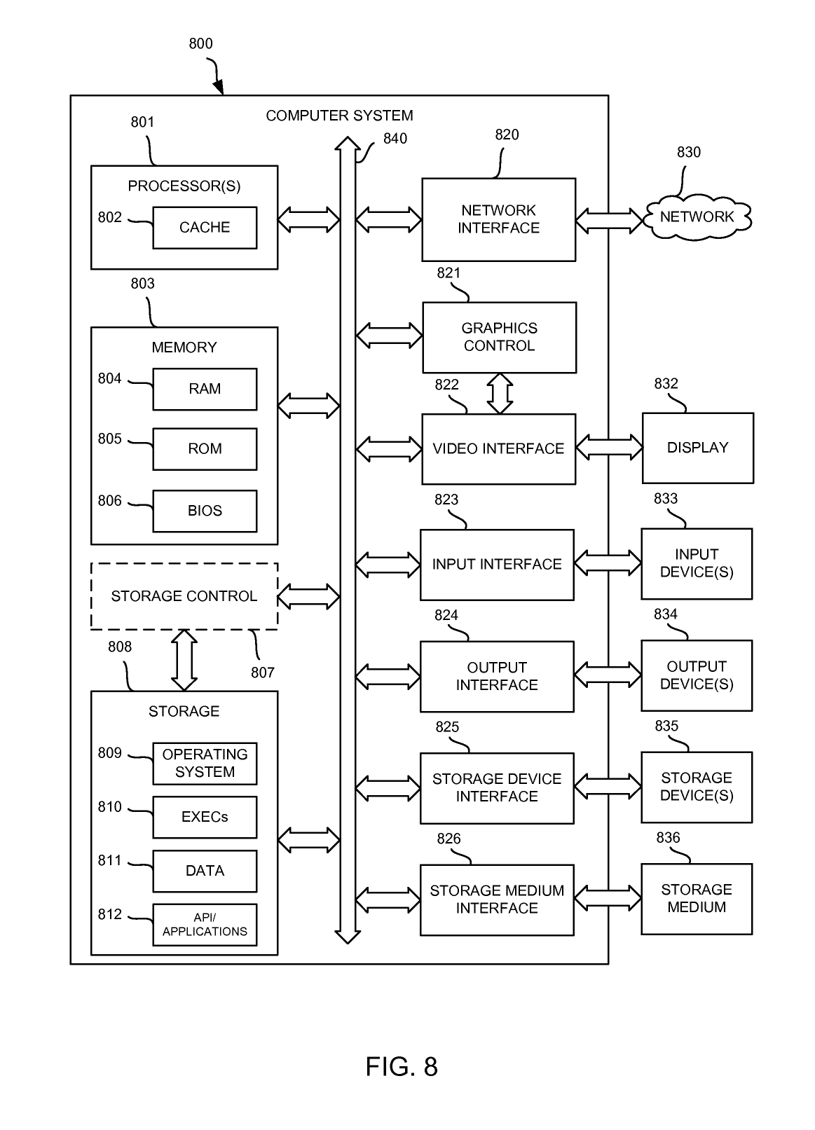

The systems and methods described herein can be implemented in a computer system in addition to the specific physical devices described herein. FIG. 8 shows a diagrammatic representation of one embodiment of a computer system 800 within which a set of instructions can execute for causing a device to perform or execute any one or more of the aspects and/or methodologies of the present disclosure. Computing system 400 in FIG. 4 is one implementation of the computer system 800. The components in FIG. 8 are examples only and do not limit the scope of use or functionality of any hardware, software, firmware, embedded logic component, or a combination of two or more such components implementing particular embodiments of this disclosure. Some or all of the illustrated components can be part of the computer system 800. For instance, the computer system 800 can be a general purpose computer (e.g., a laptop computer) or an embedded logic device (e.g., an FPGA), to name just two non-limiting examples.

Computer system 800 includes at least a processor 801 such as a central processing unit (CPU) or an FPGA to name two non-limiting examples. Cores 404, 408, and 410 in FIG. 4 each show implementations of the processor 801. In some instances, all three cores 404, 408, 410 can be part of a single multi-core processor 801. The computer system 800 may also comprise a memory 803 and a storage 808, both communicating with each other, and with other components, via a bus 840. The bus 840 may also link a display 832, one or more input devices 833 (which may, for example, include a keypad, a keyboard, a mouse, a stylus, etc.), one or more output devices 834, one or more storage devices 835, and various non-transitory, tangible computer-readable storage media 836 with each other and with one or more of the processor 801, the memory 803, and the storage 808. All of these elements may interface directly or via one or more interfaces or adaptors to the bus 840. For instance, the various non-transitory, tangible computer-readable storage media 836 can interface with the bus 840 via storage medium interface 826. Computer system 800 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 801 (or central processing unit(s) (CPU(s))) optionally contains a cache memory unit 802 for temporary local storage of instructions, data, or computer addresses. Processor(s) 801 are configured to assist in execution of computer-readable instructions stored on at least one non-transitory, tangible computer-readable storage medium. Computer system 800 may provide functionality as a result of the processor(s) 801 executing software embodied in one or more non-transitory, tangible computer-readable storage media, such as memory 803, storage 808, storage devices 835, and/or storage medium 836 (e.g., read only memory (ROM)). For instance, the method of operating a multi-core system resulting in the timing charts of FIGS. 2 and 3 may be embodied in one or more non-transitory, tangible computer-readable storage media. The non-transitory, tangible computer-readable storage media may store software that implements particular embodiments, such as the methods behind the timing charts of FIGS. 2 and 3, and processor(s) 801 may execute the software. Memory 803 may read the software from one or more other non-transitory, tangible computer-readable storage media (such as mass storage device(s) 835, 836) or from one or more other sources through a suitable interface, such as network interface 820. A wireless network interface on a smartphone is one embodiment of the network interface 820. The software may cause processor(s) 801 to carry out one or more processes or one or more steps of one or more processes described or illustrated herein. Carrying out such processes or steps may include defining data structures stored in memory 803 and modifying the data structures as directed by the software. In some embodiments, an FPGA can store instructions for carrying out functionality as described in this disclosure (e.g., the methods behind the timing charts in FIGS. 2 and 3). In other embodiments, firmware includes instructions for carrying out functionality as described in this disclosure (e.g., the methods behind the timing charts in FIGS. 2 and 3).

The memory 803 may include various components (e.g., non-transitory, tangible computer-readable storage media) including, but not limited to, a random access memory component (e.g., RAM 804) (e.g., a static RAM “SRAM”, a dynamic RAM “DRAM, etc.), a read-only component (e.g., ROM 805), and any combinations thereof. ROM 805 may act to communicate data and instructions unidirectionally to processor(s) 801, and RAM 804 may act to communicate data and instructions bidirectionally with processor(s) 801. ROM 805 and RAM 804 may include any suitable non-transitory, tangible computer-readable storage media described below. In some instances, ROM 805 and RAM 804 include non-transitory, tangible computer-readable storage media for carrying out the methods behind the timing charts in FIGS. 2 and 3. In one example, a basic input/output system 806 (BIOS), including basic routines that help to transfer information between elements within computer system 800, such as during start-up, may be stored in the memory 803.

Fixed storage 808 is connected bidirectionally to processor(s) 801, optionally through storage control unit 807. Fixed storage 808 provides additional data storage capacity and may also include any suitable non-transitory, tangible computer-readable media described herein. Storage 808 may be used to store operating system 809, EXECs 810 (executables), data 811, API applications 812 (application programs), and the like. For instance, the storage 808 could be implemented for storage of a duration of the processing period as described in FIGS. 2 and 3. Often, although not always, storage 808 is a secondary storage medium (such as a hard disk) that is slower than primary storage (e.g., memory 803). Storage 808 can also include an optical disk drive, a solid-state memory device (e.g., flash-based systems), or a combination of any of the above. Information in storage 808 may, in appropriate cases, be incorporated as virtual memory in memory 803.

In one example, storage device(s) 835 may be removably interfaced with computer system 800 (e.g., via an external port connector (not shown)) via a storage device interface 825. Particularly, storage device(s) 835 and an associated machine-readable medium may provide nonvolatile and/or volatile storage of machine-readable instructions, data structures, program modules, and/or other data for the computer system 800. In one example, software may reside, completely or partially, within a machine-readable medium on storage device(s) 835. In another example, software may reside, completely or partially, within processor(s) 801.

Bus 840 connects a wide variety of subsystems. Herein, reference to a bus may encompass one or more digital signal lines serving a common function, where appropriate. Bus 840 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 800 may also include an input device 833. In one example, a user of computer system 800 may enter commands and/or other information into computer system 800 via input device(s) 833. Examples of an input device(s) 833 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 833 may be interfaced to bus 840 via any of a variety of input interfaces 823 (e.g., input interface 823) including, but not limited to, serial, parallel, game port, USB, FIREWIRE, THUNDERBOLT, or any combination of the above.

In particular embodiments, when computer system 800 is connected to network 830 (such as a cellular network), computer system 800 may communicate with other devices, such as mobile devices and enterprise systems, connected to network 830. Communications to and from computer system 800 may be sent through network interface 820. For example, network interface 820 may receive incoming communications (such as requests or responses from other devices) in the form of one or more packets (such as Internet Protocol (IP) packets) from network 830, and computer system 800 may store the incoming communications in memory 803 for processing. Computer system 800 may similarly store outgoing communications (such as requests or responses to other devices) in the form of one or more packets in memory 803 and communicated to network 830 from network interface 820. Processor(s) 801 may access these communication packets stored in memory 803 for processing.

Examples of the network interface 820 include, but are not limited to, a network interface card, a modem, and any combination thereof. Examples of a network 830 or network segment 830 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. For instance, a cellular or home WiFi network are exemplary implementations of the network 830. A network, such as network 830, may employ a wired and/or a wireless mode of communication. In general, any network topology may be used.

Information and data can be displayed through a display 832. Examples of a display 832 include, but are not limited to, a liquid crystal display (LCD), an organic liquid crystal display (OLED), a cathode ray tube (CRT), a plasma display, and any combinations thereof. The display 832 can interface to the processor(s) 801, memory 803, and fixed storage 808, as well as other devices, such as input device(s) 833, via the bus 840. The display 832 is linked to the bus 840 via a video interface 822, and transport of data between the display 832 and the bus 840 can be controlled via the graphics control 821.

In addition to a display 832, computer system 800 may include one or more other peripheral output devices 834 including, but not limited to, an audio speaker, a printer, and any combinations thereof. Such peripheral output devices may be connected to the bus 840 via an output interface 824. Examples of an output interface 824 include, but are not limited to, a serial port, a parallel connection, a USB port, a FIREWIRE port, a THUNDERBOLT port, and any combinations thereof.

In addition or as an alternative, computer system 800 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Within this specification, the same reference characters are used to refer to terminals, signal lines, wires, etc. and their corresponding signals. In this regard, the terms “signal,” “wire,” “connection,” “terminal,” and “pin” may be used interchangeably, from time-to-time, within the this specification. It also should be appreciated that the terms “signal,” “wire,” or the like can represent one or more signals, e.g., the conveyance of a single bit through a single wire or the conveyance of multiple parallel bits through multiple parallel wires. Further, each wire or signal may represent bi-directional communication between two, or more, components connected by a signal or wire as the case may be.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein (e.g., the methods behind the timing charts in FIGS. 2 and 3) may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A multi-core system comprising:
a peripheral memory device comprising data to be read and processed;
a controller that sends a control signal once per processing period;
a memory;
a first core coupled to the memory and coupled to the controller and comprising a non-transitory, tangible computer readable storage medium, encoded with processor readable instructions to perform a method for operating the core, the method comprising:
receiving a first instance of the control signal and then:
reading a first portion of the data from the peripheral memory device;
processing the first portion of the data;
converting the first portion of data to a processed first portion of the data; and
writing the processed first portion of the data to the memory;
receiving a second instance of the control signal and then:
reading a second portion of the data from the peripheral memory device; and
a second core coupled to the memory and coupled to the controller and comprising a non-transitory, tangible computer readable storage medium, encoded with processor readable instructions to perform a method for operating the core, the method comprising:
receiving a second instance of the control signal; and
reading the processed first portion of the data from the memory.

2. The multi-core system of claim 1, further comprising a system bus via which the first and second cores communicate.

3. The multi-core system of claim 2, wherein the first core communicates with the peripheral memory device via the system bus.

4. The multi-core system of claim 3, wherein the first core communicates with the peripheral memory device via a peripheral bus.

5. The multi-core system of claim 1, wherein the second core communicates with the memory via a system bus.

6. The multi-core system of claim 5, wherein the second core communicates with the memory via a memory bus.

7. The multi-core system of claim 1, wherein the first core communicates with the memory via a system bus.

8. The multi-core system of claim 7, wherein the first core communicates with the memory via a memory bus.

9. The multi-core system of claim 1, wherein the first core is an application core.

10. The multi-core system of claim 9, wherein the second core is a digital signal processing core.

11. The multi-core system of claim 1, wherein the second core cannot process a portion of the data from the peripheral memory device until the first core has processed the portion of the data from the peripheral memory device.

12. A method of operating a multi-core system comprising:
sending a first instance of a control signal to two or more cores of a computing device;
reading, via a first of the two or more cores, a first portion of data from a peripheral memory device, processing the first portion of data, and writing the first portion of data to a memory of the computing device, upon receiving a first instance of the control signal;
sending a second instance of the control signal to the two or more cores of the computing device;
reading, via the first of the two or more cores, a second portion of data from the peripheral memory device, upon receiving the second instance of the control signal; and
reading, via a second of the two or more cores, the first portion of data from the memory, upon receiving the second instance of the control signal.

13. The method of claim 12, further comprising:
processing the first portion of data upon receipt of the second instance of the control signal; and
writing the first portion of data to the memory upon receipt of the second instance of the control signal.

14. A non-transitory, tangible computer readable storage medium, encoded with processor readable instructions to perform a method for operating a multi-core system, the method comprising:
sending a first instance of a control signal to two or more cores of a computing device;
reading, via a first of the two or more cores, a first portion of data from a peripheral memory device, processing the first portion of data, and writing the first portion of data to a memory of the computing device, upon receiving a first instance of the control signal;
sending a second instance of the control signal to the two or more cores of the computing device;
reading, via the first of the two or more cores, a second portion of data from the peripheral memory device, upon receiving the second instance of the control signal; and
reading, via a second of the two or more cores, the first portion of data from the memory, upon receiving the second instance of the control signal.

15. The non-transitory, tangible computer readable storage medium of claim 14, wherein the first and second of the two or more cores read and write data via a system bus.

16. The non-transitory, tangible computer readable storage medium of claim 14, wherein the second of the two or more cores reads and writes data via a memory bus.

17. The tangible computer readable storage medium of claim 14, wherein a second of the two or more cores processes the first portion of data and writes the first portion of data back to the memory after ready the first portion of the data from the memory.

18. The tangible computer readable storage medium of claim 17, wherein a third of the two or more cores reads the first portion of data from the memory upon receiving a third instance of the control signal.

19. The tangible computer readable storage medium of claim 14, wherein each instance of the control signal is separated from a next instance of the control signal by a processing period.
